(19) United States
(12) Patent Application Publication
(10) Pub. No.: US 2002/0116312 A1
(43) Pub. Date: Aug. 22, 2002

(54) Method and apparatus for providing a reverse blind electronic credit auction

(76) Inventors: Kevin L. Talbot, Ontario (CA); Duncan A. Ross, Novato, CA (US); Arlene A. Greene, Winchester, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 09/730,511

(22) Filed: Dec. 5, 2000

(51) Int. Cl. G06F 17/60

(52) U.S. Cl. 705/37

(57) ABSTRACT

A reverse blind credit auction between a borrower and at least one lender assists the borrower in creating an electronic credit application. The credit application is processed by authenticating information in the credit application, scoring the credit application using a masked credit report such that a credit report inquiry indication is not entered on the credit report of the borrower and filtering the credit application. Further, based upon screening criteria provided by the lenders, a processor routine matches the credit application to one or more lenders. A subset of the processed credit application and the masked credit report is transmitted to the matched lender, or lenders, that make a credit offer decision. The credit offer decisions are then transmitted to the borrower. When one of the matched lender receives notification of a selected offer from the borrower, the borrower identification information matching the selected offer to the lender associated with the selected offer is made available such that the lender associated with the selected offer can contact the borrower to further process the credit application.

### RELATED APPLICATIONS

This application is related to co-pending U.S. patent application titled “METHOD AND APPARATUS FOR RECYCLING DECLINED CREDIT APPLICATIONS” by Kevin L. Talbot, Duncan A. Ross and Stephanie A. Febonio (Attorney Docket Number 3059.1001-000), filed on even date, the entire teachings of which are incorporated herein by reference.

### BACKGROUND OF THE INVENTION

This invention relates generally to electronic credit auctions, and more specifically reverse blind electronic credit auctions providing for financial institution bidding using masked credit reports.

Borrowers apply for credit for many reasons, using a variety of options. Traditionally, a borrower would go to the local branch of their bank and apply for a loan to cover an anticipated expense or large purchase. Customer loyalty to a single bank has diminished as more and more options are created for borrowers to get exposure to offers from multiple lenders. With the advent of online lending, a borrower can complete a single electronic credit application and instantly apply for credit from multiple lending institutions using a reverse auction process. In a reverse auction process the lenders bid on the borrower's credit request. Sources for electronic credit applications include Web standalone kiosk-style electronic information interfaces, Web pages for sellers of products and services that may require financing in order to consummate a sale, or by telephone.

Traditional and virtual banks typically provide specific credit products, for example home mortgages, automobile loans, credit cards, equity loans and lines of credit. These lender products have criteria based upon the purpose of the loan as well as criteria based upon the creditworthiness of the borrower. Creditworthiness is often determined from credit reports available from one of many credit reporting services (e.g., EquiFax, Experian). When a lender requests a credit report for a potential borrower a notation is made on the borrower's credit report. A series of notations may indicate a borrower is making a large number of credit requests. Additionally, credit reports can contain a borrower's name and address. Borrower's may not want this information factored into their credit evaluation.

Currently, systems exist to provide reverse credit auctions. LendingTree Inc. (www.lendingtree.com) of Charlotte, N.C., USA. provides an online loan marketplace where lenders bid for borrower's business and allow borrowers to choose among multiple loan offers including terms and rates. Lendex (www.lendx.com) of San Francisco, Calif., USA is an online corporate equipment finance marketplace that provides access to a broad range of lenders in a neutral and competitive marketplace. Proposals are analyzed and sorted according to borrower-specified time-lines and criteria, making the decision-making process more efficient and effective. Oinke, Inc. (www.oinke.com) of Irvine, Calif., USA also provides credit auctioning using their FAT™ financial auction technology.

### SUMMARY OF THE INVENTION

The present invention provides a reverse blind electronic credit auction. Users complete a single electronic credit application from which they can receive multiple offers of credit from financial institutions. The system is a “reverse” auction because financial institutions bid to make offers for a borrower's needs, instead of borrowers bidding for financial institution's products. The system is “blind” because it provides for the masking of certain identifying attributes (e.g., borrower's name and address, except state) from the credit report generated using data from the electronic credit application.

The credit application is processed and scored, then submitted, along with the masked credit report, to the reverse blind credit server providing a lender network. The scoring involves acquiring a credit report in such a way that the borrower's credit history is not effected by the credit request. The credit application is filtered according to lender supplied criteria and transmitted to matching lenders. Lenders then bid on the credit request, offering their products and terms. Lenders are not given borrower's contact information at this time. Borrowers whose credit requests generate offers (bids) are notified of those detailed offers using the reverse blind credit server. When a borrower either receives or chooses a specific offer, the reverse blind credit server transmits contact information to the lender such that an agreement between the borrower and lender can be established.

The present invention provides a method, apparatus and article of manufacture for providing a reverse blind credit auction between a borrower and multiple lenders by assisting the borrower in creating an electronic credit application. The credit application is processed by authenticating the information in the credit application, scoring the credit application using a masked credit report such that a credit report inquiry indication is not entered on the credit report of the borrower and filtering the credit application, based upon screening criteria provided by each lender, to match the credit application to each such lender. A subset of the processed credit application and the masked credit report is transmitted to the matched lender(s) and the matched lender(s) makes a credit offer decision. Each credit offer decision is then transmitted to the borrower. When a matched lender receives notification of a selected offer from the borrower, the borrower identification information matching the selected offer to the lender associated with the selected offer is made such that the lender associated with the selected offer can contact the borrower to further process the credit application.

Various types of credit requests are possible with the present invention including requests for loans, leases, lines of credit and credit card accounts. Authentication of the credit application information for the credit requests include verifying that the borrower's zip code and the borrower's phone area code match the same region. Additionally, fraudulent loan applications are detected based upon checking the credit application against a database of past fraudulent credit applications.

Since some lenders may use existing credit application forms which are a different format than those used in a preferred embodiment of the present invention. An embodiment of the present invention presents the borrower with one or more computer enabled application forms containing data entry fields which map to data contained in reverse blind credit auction server form. Mapping may include use of an XML, or other, equivalency table.

The present invention also supports an auto-bidding process for lenders that can define a set of preprogrammed bidding rules. The auto-bidding process can be programmed to read information from the credit application, credit report and credit score as well as the lender's criteria to programmatically determine an appropriate bid for the credit request.

The present invention has benefits for both borrowers and lenders. Borrowers get exposure to multiple lenders without having their credit reports reflect multiple inquiries (or “pulls”). Thus, the present invention enables “soft-pulls”. The credit reports are masked, providing a degree of assurance that no discrimination based upon gender, address, age or the like is occurring in the lending process. Lenders get exposure to more pre-qualified borrowers using lender-driven filtering criteria.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 illustrates a computer system on which an embodiment of the present invention is implemented.

FIG. 2 illustrates the internal structure of a computer of FIG. 1.

FIG. 3 is a diagram of components in an embodiment of the present invention along with various input and output interactions.

FIG. 4 is a state diagram for a credit request as it is processed by an embodiment of the present invention.

FIG. 5 is a flowchart of the hierarchical filtering process for lenders configured according to an embodiment of the present invention.

### DETAILED DESCRIPTION OF THE INVENTION

A description of preferred embodiments of the invention follows.

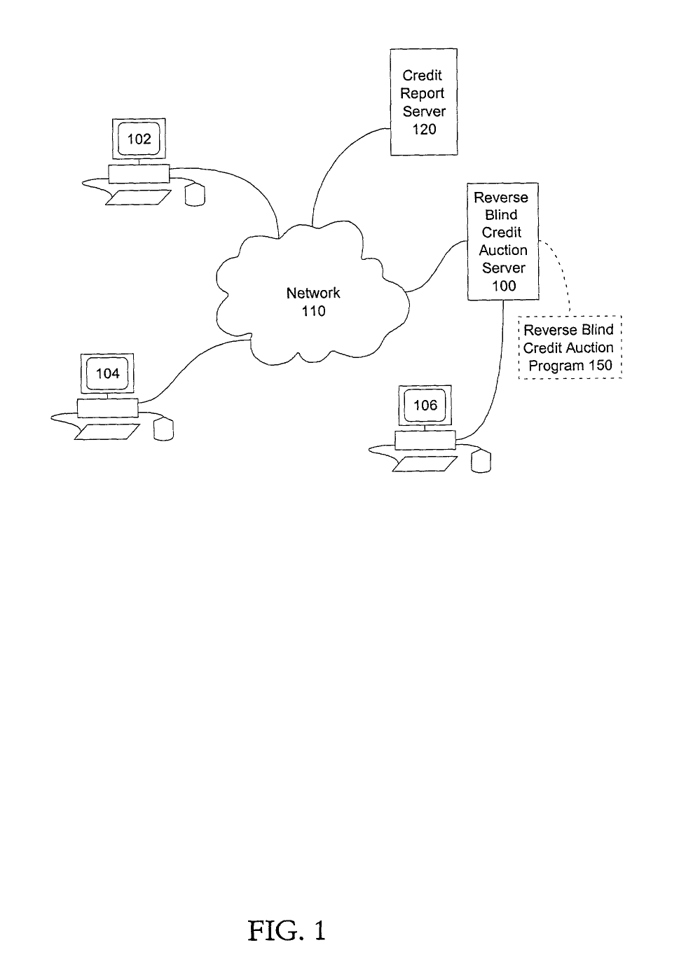

FIG. 1 illustrates a computer system on which an embodiment of the present invention is implemented. Client computers (102, 104, 106) are linked to network 110 and provide processing and input/output devices in a system providing a reverse blind credit auction. Server computers (100, 120) are also linked to a network 110 and contain software for providing a reverse blind credit auction. Network 110 can be part of the Internet, the worldwide collection of computers, networks and gateways that use the TCP/IP suite of protocols to communicate with one another. The Internet provides a backbone of high-speed data communication lines between major nodes and host computers, consisting of thousands of commercial, government, educational, and other computer systems, that route data and messages.

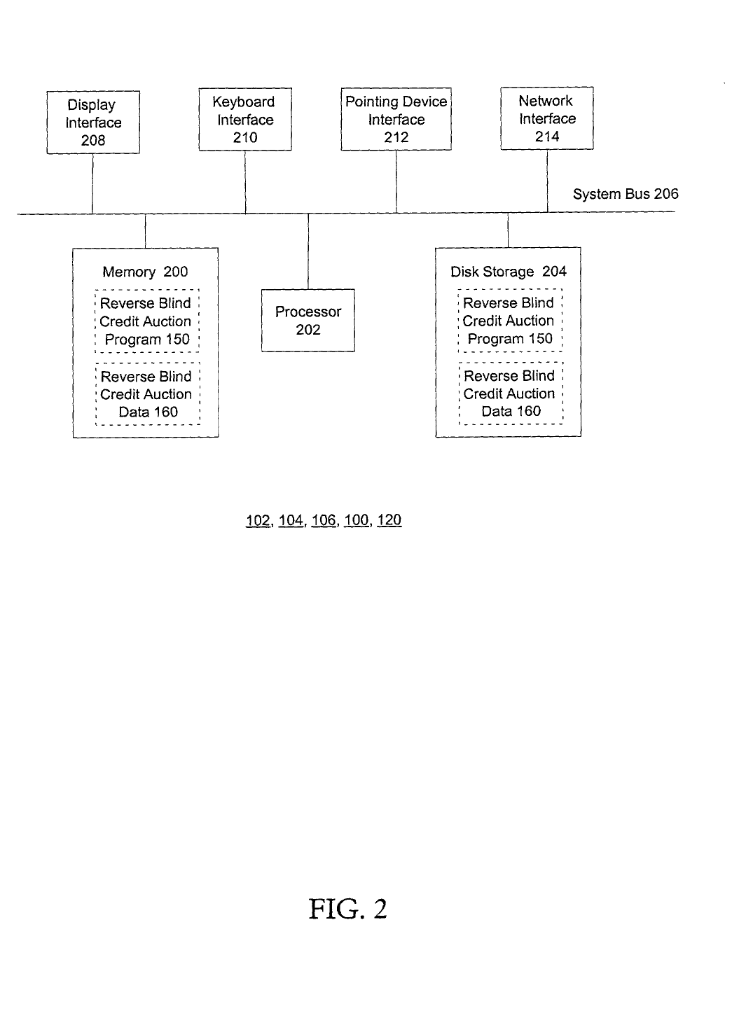

In one embodiment of the present invention, a Reverse Blind Credit Auction program 150 executes on Reverse Blind Credit Auction server 100 and a Credit Report process executes on Credit Report server 120. Alternatively, the Reverse Blind Credit Auction program 150 and Credit Report process can execute on the same server. FIG. 2 illustrates the internal structure of a computer of FIG. 1. FIG. 2 illustrates client computer (102, 104, 106) and the server computers (100,120). The client computers (102, 104, 106) and server computers (100,120) contain a system bus 206; a bus is a set of hardware lines used for data transfer among the components of a computer system. A bus is essentially a shared channel that connects different parts of the system (e.g., processor, disk-drive controller, memory, and input/output ports) and enables the different parts to transfer information. Attached to system bus 206 is display interface 208, which allows display devices to communicate with other components on system bus 206. Keyboard interface 210 and pointing device interface 212 are also attached to system bus 206 and allow various input devices to communicate with other components on system bus 206. Network interface 214 provides a link to an external network (e.g., network 110) allowing processes running on a client computer (102, 104, 106) to communicate with a server computer (100,120) connected to network 110. Memory 200 stores computer software instructions and data structures used to implement an embodiment of the present invention (e.g., Reverse Blind Credit Auction Program 150). A disk storage device 204 is provided for non-volatile storage on computers (102, 104, 106, 100, 120) to store, for example Reverse Blind Credit Auction Program 150. A processor 202 executes instructions and accesses data stored in memory 200, allowing the networked computers (102, 104, 106, 100, 120) to provide a reverse blind credit auction according to an embodiment of the present invention.

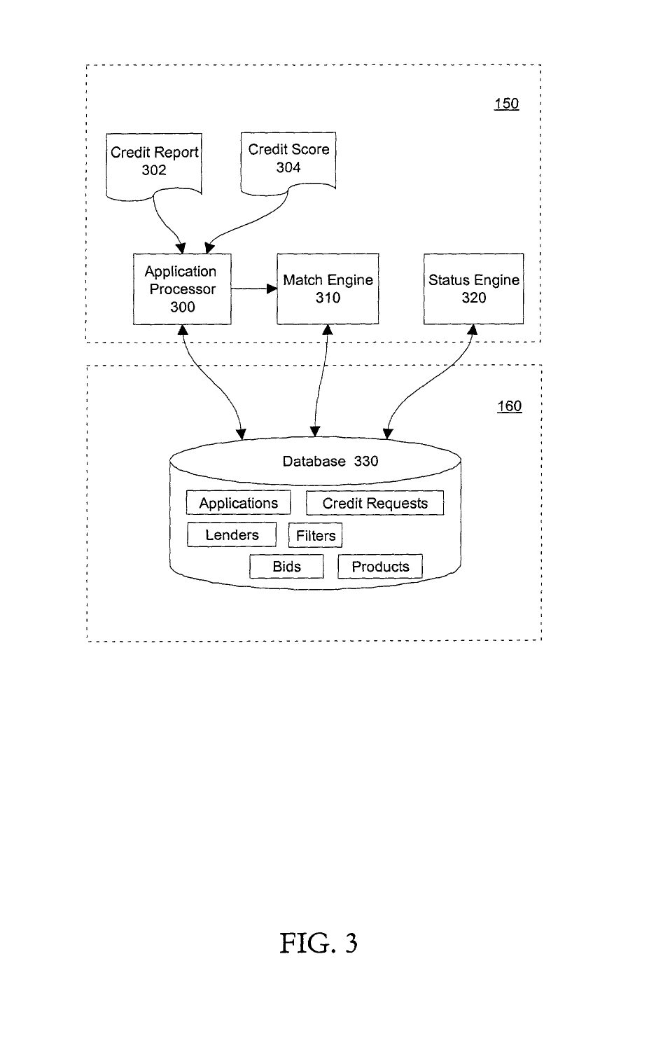

FIG. 3 is a diagram of components in an embodiment of the present invention along with various input and output interactions. In this embodiment, a Reverse Blind Credit Auction Program 150 is implemented using Credit Report server 120 and Reverse Blind Credit Auction server 100. Credit Report server 120 and Reverse Blind Credit Auction server 100 may be a single physical computer, or multiple physical computers. Reverse Blind Credit Auction Program 150 interacts with Reverse Blind Credit Auction Data 160 to provide a reverse blind credit auction.

A database 330 stores data objects used to provide a reverse blind credit auction. Electronic credit applications (Applications) are stored at various points during the application process, both as checkpoints and completed credit applications. Information about the lenders within the network and their products is also stored along with filters built to implement the various criteria that lenders define for their specific product offers. A processed credit application can become a credit request that lenders within the network can bid on. The credit requests and bids are stored in database 330.

Reverse Blind Credit Auction Program 150 provides various processing capabilities that assist in providing a reverse blind credit auction. An online credit application is initially processed by application processor 300. Application processor 300 checks for consistent and/or fraudulent data within the electronic credit application. Inconsistency checks include zip codes that don't match a city or town specified, zip codes that don't match telephone area code specified and various other out of bounds entries. Additionally, fraud can be detected by comparing an electronic credit application to a set of known, historically fraudulent applications.

A credit report 302 is obtained from one, or more, of many credit reporting services (e.g., TransUnion, Dun & Bradstreet). Various parts of the credit report (e.g., name, address (except state), gender, age) are masked, such that a bidding lender will not see them. Some, or all, of the masked parts may be subsequently revealed to a winning bidder (lender) if an applicant chooses the lender's bid. Additionally, a credit score 304 is generated using information in the electronic credit application and information in the credit report 302. In one preferred embodiment, the credit scoring is provided by the Small Business Scoring Service™ by Fair, Isaac & Company, an information services company headquartered in San Rafael, Calif., USA.

The credit application, along with associated credit reporting and/or credit scoring information is processed by a match engine 310. Match engine 310 matches the credit application to a lender's products based upon predefined criteria specified by the lender's inputs and the borrower's credit application, credit report 302 and credit score 304.

The status engine 320 executes as a scheduled process. Status information for credit requests and other objects represented by the reverse blind credit auction data 160 is checked by status engine 320. The status engine 320 also updates status information 8(e.g., a credit request without a bid by a lender after five calendar days will be set to closed:expired).

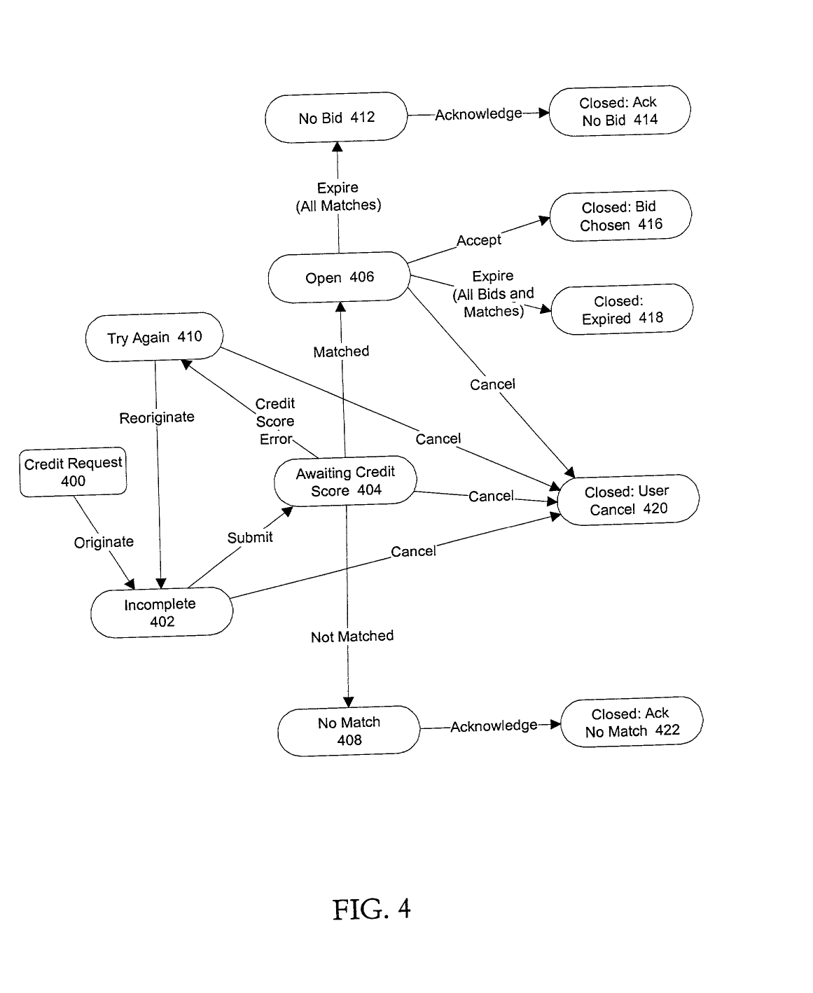

FIG. 4 is a state diagram for a credit request as it is processed by an embodiment of the present invention. A credit request 400 is initiated by an applicant by filling out an electronic credit application. The credit request 400 is in an incomplete 402 state until it is submitted or canceled. When an applicant saves the credit application (e.g., as a checkpoint prior to submission), the credit request 400 is also set to incomplete 402 state. If credit request 400 is canceled the credit request 400 state is set to a closed:user cancel 420 state. At various points in the credit auction process, including after ab application has been submitted, a credit request 400 may be canceled, setting a credit request 400 state to cancel correspondingly causes all existing matches and bids associated with that credit request 400 to be canceled.

When credit request 400 is submitted, the credit request 400 state is set to awaiting credit score 404, this triggers a process to create a credit score for the credit request 400. If a credit score could not be created, the credit request 400 state is set to a try again 410 state. At this state the credit request 400 applicant may be informed of any errors and/or additional information needed for a credit score to be created. The credit request 400 may be re-originated to reenter the incomplete 402 state, with possibly corrected applicant information.

Once a credit score is obtained, a process can attempt to match the credit request 400 to the lenders' criteria. If the credit request 400 does not match any the criteria of any lenders, credit request 400 is set to no match 408 state, an acknowledgment is noted and the state is then set to closed: acknowledgment no match 422. If the credit request 400 matches the criteria of a lender, credit request 400 is set to open 406 state. In open 406 state, the credit request 400 is sent to lenders within the network for soliciting bids, if no bids are received the credit request 400 is then set to no bid 412 state, an acknowledgment is noted and the state is set to closed:acknowledgment no bid 414.

A credit request 400 in open 406 state can accept a bid and enter the closed:bid chosen 416 state, thereby enabling the winning lender and credit request 400 applicant to enter an agreement to provide credit. The winning lender is automatically sent a credit report that does result in a notation on the borrower's credit report (“hard-pull”). At this point the masked information in credit request 400 is revealed to the winning lender such that further processing of the credit application is enabled. Otherwise, if no bids are accepted, the credit request 400 expires, along with all bids and matches, and the state is set to closed:expired 418.

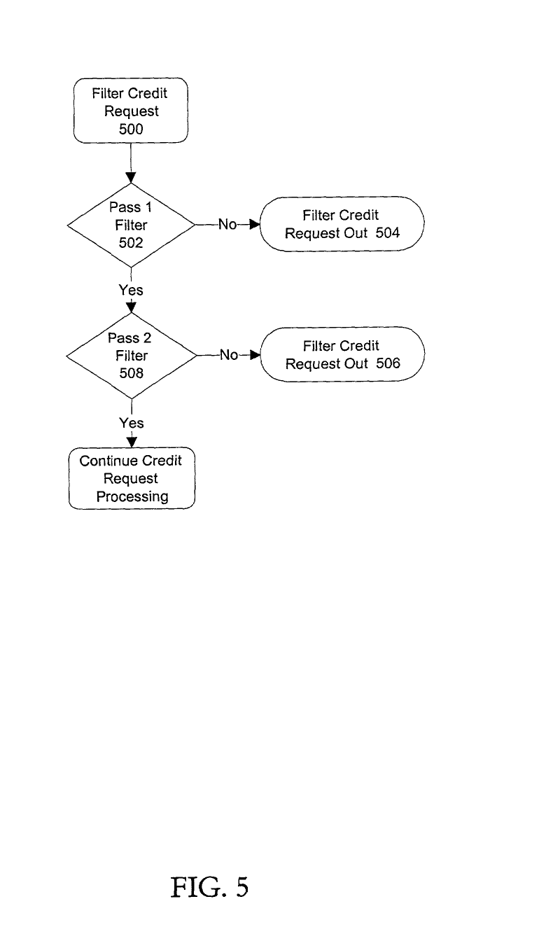

FIG. 5 is a flowchart of the hierarchical filtering process for lenders configured according to an embodiment of the present invention.

Financial institutions (lenders) become members of the computer network by submitting information about themselves and their products. This information can be gathered using computer-enabled forms and includes such things as: financial institution name, administrator name, list of contacts, products offered, product notification address and filtering factor information.

Information supplied by the financial institution is stored in database 330. The filtering factors are stored as data and rules (e.g., stored procedures and triggers), this allows for effective management of information from multiple financial institutions. Single value factors and multiple value factors are encoded, stored and accessed from database 330. A standard rules processing engine (e.g., SQL Server 7.0) is utilized to execute the desired exclusions for the financial institutions.

Filtering factors are divided into two categories, 1) factors that have a single value such as: secured/unsecured, minimum/maximum, bankruptcy/non-bankruptcy, and 2) factors that can have multiple values such as: loan purpose, business address state and Standard Industry Classification (“SIC”) code. Each set of factors is stored in separate filtering database tables.

The Filter Credit Request process (Step 500) begins by running a first-pass filter (filter 1) involving single value factors against the credit request. For example a certain lender targeting small businesses may define the following single value exclusions:

loan amounts below $500,000;

loan amounts above $5,000,000;

delinquent taxes;

bankruptcy;

Experian Business (SBI) score below 75; or

Fair, Isaac & Company (SBSS) score below 300.

If it is determined (Step 502) that any of the single value exclusions apply the credit request is filtered out (Step 504) and will not be shown to that lender. If none of the single value exclusions apply the credit request will be filtered by a second-pass filter (filter 2) involving multiple value factors. For example, a list of certain states and/or SIC codes.

If it is determined (Step 508) that any of the multiple value exclusions apply the credit request is filtered out (Step 506) and will not be shown to that lender. If none of the multiple value exclusions apply, the credit request, along with the soft-pulled credit report, credit score and at least part of the credit application, is transmitted to matching lenders for bidding. Once the credit requests are made available to matched lenders, the lenders may bid on the credit requests. Reverse Blind Credit Auction server 100 collects the bids and makes them available to the borrower for viewing. Each credit request is represented by a unique identifier/key, such that lenders can bid on specific credit requests without knowing the identity of the originator of the credit request.

Bids are communicated to borrowers using various communications means, including electronic mail, facsimile, phone, secure intranet and the like. Borrower's responses to the bids are collected on Reverse Blind Credit Auction server 100. When a winning lender follows up on a winning bid, the lender contacts Reverse Blind Credit Auction server 100 and receives contact information for the borrower and an umnasked credit report. The winning lender may now perform further analysis that may lead to a credit agreement with the borrower.

While this invention has been particularly shown and described with references to preferred embodiments thereof, it will be understood by those skilled in the art that various changes in form and details may be made therein without departing from the scope of the invention encompassed by the appended claims.

For example a lender is not necessarily a traditional bank; other financial institutions including mortgage lenders, insurance companies and private equity providers may act as lenders. A person of ordinary skill in the art will recognize these, as well as other, financial institutions that may act as lenders within the scope of the present invention.

What is claimed is:

1. A method of providing a reverse blind credit auction between a borrower and at least one lender, comprising the steps of:
assisting the borrower in creating an electronic credit application;
processing the credit application, the processing steps comprising:
authenticating information in the credit application;
scoring the credit application using a masked credit report such that a credit report inquiry indication is not entered on the credit report of the borrower;
filtering the credit application, based upon screening criteria provided by the lenders, to match the credit application to the lenders;
transmitting a subset of the processed credit application and the masked credit report to the matched lenders, at least one of the matched lenders making a credit offer decision;
transmitting one or more of the credit offer decisions to the borrower;
receiving notification of a selected offer from the borrower; and
transmitting the borrower identification information matching the selected offer to the lender associated with the selected offer, such that the lender associated with the selected offer can contact the borrower to further process the credit application.

2. The method of claim 1 wherein the credit application comprises a request for at least one of the following types of credit:
a loan, a lease, a line of credit, and a credit card account.

3. The method of claim 1 wherein the step of authenticating comprises:
verifying that the borrower zip code and the borrower phone area code match the same region.

4. The method of claim 1 wherein the step of authenticating comprises:
detecting fraudulent loan applications based upon checking the credit application against a database of historically fraudulent credit applications.

5. The method of claim 1 wherein the step of assisting the borrower in creating an electronic credit application includes presenting the borrower with one or more computer enabled application forms containing data entry fields which can be mapped to data contained in a separate application form.

6. The method of claim 5 wherein the data entry fields are mapped using an XML, or other, equivalency table.

7. The method of claim 1 wherein at least one of the matched lenders is represented by a set of preprogrammed bidding rules, thereby creating an automatic bidding process for at least one of the matched lenders.

8. An apparatus providing a reverse blind credit auction between a borrower and at least one lender, comprising:
a preprocessor assisting the borrower in creating an electronic credit application;
a processor authenticating information in the credit application, scoring the credit application using a masked credit report such that a credit report inquiry indication is not entered on the credit report of the borrower; and
filtering the credit application, based upon screening criteria provided by the lenders, to match the credit application to the lenders;
first transmitter transmitting a subset of the processed credit application and the masked credit report to the matched lenders, at least one of the matched lenders making a credit offer decision;
a second transmitter transmitting one or more of the credit offer decisions to the borrower;
a receiver receiving notification of a selected offer from the borrower;
and
a third transmitter transmitting the borrower identification information matching the selected offer to the lender associated with the selected offer, such that the lender associated with the selected offer can contact the borrower to further process the credit application.

9. The apparatus of claim 8 wherein the credit application comprises a request for at least one of the following types of credit:
a loan, a lease, a line of credit, and a credit card account.

10. The apparatus of claim 8 wherein authenticating comprises:
verifying that the borrower zip code and the borrower phone area code match the same region.

11. The apparatus of claim 8 wherein authenticating comprises:
detecting fraudulent loan applications based upon checking the credit application against a database of historically fraudulent credit applications.

12. The apparatus of claim 8 wherein the preprocessor presents the borrower with one or more computer enabled application forms containing data entry fields which can be mapped to data contained in a separate application form.

13. The apparatus of claim 12 wherein the data entry fields are mapped using an XML, or other, equivalency table.

14. The apparatus of claim 8 wherein at least one of the matched lenders is represented by a set of preprogrammed bidding rules, thereby creating an automatic bidding process for at least one of the matched lenders.

15. An apparatus providing a reverse blind credit auction between a borrower and at least one lender, comprising:
a means for assisting the borrower in creating an electronic credit application;
a means for processing the credit application, the processing steps comprising:
authenticating information in the credit application;
scoring the credit application using a masked credit report such that a credit report inquiry indication is not entered on the credit report of the borrower;
filtering the credit application, based upon screening criteria provided by the lenders, to match the credit application to the lenders;
a means for transmitting a subset of the processed credit application and the masked credit report to the matched lenders, at least one of the matched lenders making a credit offer decision;
a means for transmitting one or more of the credit offer decisions to the borrower;
a means for receiving notification of a selected offer from the borrower; and
a means for transmitting the borrower identification information matching the selected offer to the lender associated with the selected offer, such that the lender associated with the selected offer can contact the borrower to further process the credit application.

16. A computer program product comprising:
a computer usable medium for providing a reverse blind credit auction between a borrower and at least one lender; and
a set of computer program instructions embodied on the computer usable medium, including instructions to:
assist the borrower in creating an electronic credit application;
process the credit application, the processing comprising:
authenticating information in the credit application;
scoring the credit application using a masked credit report such that a credit report inquiry indication is not entered on the credit report of the borrower;
filtering the credit application, based upon screening criteria provided by the lenders, to match the credit application to the lenders;
transmit a subset of the processed credit application and the masked credit report to the matched lenders, at least one of the matched lenders making a credit offer decision;
transmit one or more of the credit offer decisions to the borrower;
receive notification of a selected offer from the borrower; and
transmit the borrower identification information matching the selected offer to the lender associated with the selected offer, such that the lender associated with the selected offer can contact the borrower to further process the credit application.

17. A computer data signal embodied in a carrier wave comprising a code segment for providing a reverse blind credit auction between a borrower and at least one lender; and
a set of computer program instructions embodied in the code segment, including instructions to:
assist the borrower in creating an electronic credit application;
process the credit application, the processing comprising:
authenticating information in the credit application;
scoring the credit application using a masked credit report such that a credit report inquiry indication is not entered on the credit report of the borrower;
filtering the credit application, based upon screening criteria
provided by the lenders, to match the credit application to the lenders;
transmit a subset of the processed credit application and the masked credit report to the matched lender, at least one of the matched lenders making a credit offer decision;
transmit one or more of the credit offer decisions to the borrower;
receive notification of a selected offer from the borrower; and
transmit the borrower identification information matching the selected offer to the lender associated with the selected offer, such that the lender associated with the selected offer can contact the borrower to further process the credit application.
